(19) United States
(12) Patent Application Publication
(10) Pub. No.: US 2018/0063020 A1
(43) Pub. Date: Mar. 1, 2018

(54) CENTRALLY MANAGED TIME SENSITIVE FOG NETWORKS

(71) Applicant: Nebbiolo Technologies, Inc., Milpitas, CA (US)

(72) Inventors: Ravi Bhagavatula, Milpitas, CA (US); Pankaj Bhagra, Fremont, CA (US)

(21) Appl. No.: 15/687,396

(22) Filed: Aug. 25, 2017

Related U.S. Application Data
(60) Provisional application No. 62/382,200, filed on Aug. 31, 2016.

(51) Int. Cl. H04L 12/911; H04L 12/927

(52) U.S. Cl. CPC H04L 47/781; H04L 47/80; H04L 47/82

(57) ABSTRACT

Centrally managed time sensitive fog networks are disclosed herein. An example fog network includes a plurality of dynamic end points, a plurality of service specific nodes offering one or more services selected from compute, storage, network, security, and business critical applications and functions, one or more fog nodes providing distributed resource management for plurality of services, and one or more system managers that provide centralized control of the one or more services to the plurality of dynamic end points.

### CROSS REFERENCE TO RELATED APPLICATIONS

This application claims the benefit and priority of U.S. Provisional Application Ser. No. 62/382,200, filed on Aug. 31, 2016, which is hereby incorporated by reference in its entirety, including all references and appendices cited therein.

### FIELD OF INVENTION

The present disclosure is directed to network management, and more specifically, but not by limitation to centrally managed time sensitive networks, such as an Ethernet time sensitive network (TSN). Some embodiments include a centrally managed TSN with TSN switches embedded in a fogNode, which can be deployed in a Fog architecture. The Fog deployment allows for centralized hosting of various hosted services, role based access control for the hosted services, and application hosting, as well as other features described herein.

### SUMMARY

According to some embodiments, the present disclosure is directed to a system comprising a plurality of end points; one or more fogNodes providing distributed resource management of resources from a plurality of service pools for the plurality of end points; one or more time sensitive network (TSN) switches embedded within the one or more fogNodes; and a system manager or lead fogNode of the one or more fogNodes that provides centralized hosting of both a central user configurator and a central network configurator.

According to some embodiments, the present disclosure is directed to a Fog network comprising a plurality of end points, one or more fogNodes providing distributed resource management of resources from a plurality of resource pools for the plurality of end points, one or more time sensitive network (TSN) switches embedded within the one or more fogNodes; and a system manager or lead fogNode of the one or more fogNodes that provides centralized management and selective distribution of plurality of resource pools to the plurality of end points using resource profiles for the plurality of end points.

According to some embodiments, the present disclosure is directed to a fog network comprising a plurality of dynamic end points; a plurality of service specific nodes offering one or more services comprising compute, storage, network, security, and business critical applications and functions; one or more fog nodes providing distributed resource management for plurality of services; and one or more system managers that provide centralized control of the one or more services to the plurality of dynamic end points.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a schematic diagram of an example fog network constructed in accordance with the present disclosure.

FIG. 2 is a schematic diagram of another example fog network constructed in accordance with the present disclosure.

FIG. 3 illustrates an exemplary computing system that may be used to implement embodiments according to the present technology.

### DETAILED DESCRIPTION

Fog computing facilitates management of Industrial devices like robots, CNC (computer numeric controlled) machines, manufacturing machines, sensors, actuators, power management devices, air handlers, coolant circulating pumps and other devices, which are collectively called operational technology (OT) devices, are present in industrial floor, power plants, oil and gas rigs, high end data centers and other sectors. Many other OT devices exist and would be known to one of ordinary skill in the art.

A Fog also provides for a “local” distributed resource management paradigm. This entails the availability of enough compute, storage, network, security resources closer to the data sources (machines, controls, etc.). This is especially attractive to an industrial floor like environment, wherein the producers and consumers of data are all co-located within a single roof.

The main constituent of a Fog is a fogNode (FN), which dons multiple hats depending upon the deployment model. On one hand, an FN could be a network gateway for a deployment. On the other hand, it could participate in a distributed asset management and monitoring solution.

In some embodiments, a unique aspect of a Fog is the presence of an Ethernet Time Sensitive Network (TSN). According to some embodiments, a Fog could use any of the following options with regard to provisioning TSN end-points. In some embodiments, the TSN can deploy a centralized control element which generates TSN schedules, and provisions TSN elements with such schedules. In another embodiment, the TSN can implement a hop-by-hop approach where participating TSN elements generate TSN schedules based on per-flow heuristics. In some embodiments, the TSN can implement both of the centralized and hop-by-hop approaches.

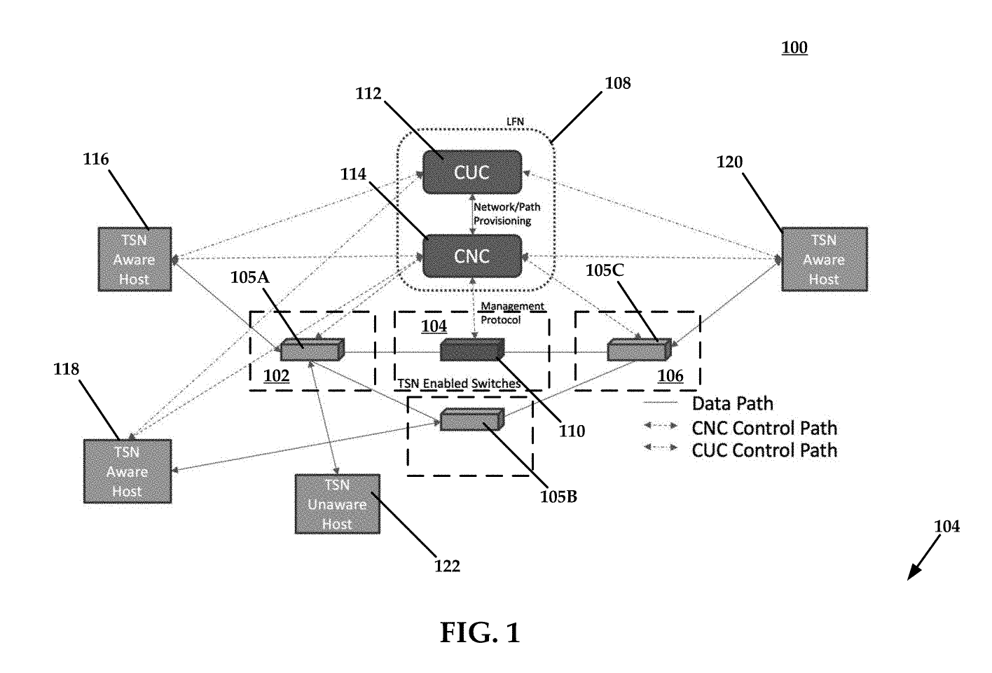

FIG. 1 is a schematic diagram of an example fog network 100 that is configured and constructed in accordance with the present disclosure. The Fog network 100 implements an example centrally managed scheme.

In some embodiments, the fog network 100 comprises a plurality of fogNodes 102-108, with fogNode 108 being a lead fogNode. The fog network 100 also comprises TSN switches 105A-C embedded in each of the fogNodes 102-106, and a TSN capable switch 110. The TSN capable switch 110 is not embedded in a fogNode. In some embodiments, the Fog network 100 comprises network services such as a central user configurator (CUC) 112 and central network configurator (CNC) 114. These network services can be embedded or centrally managed in the lead fogNode 108. In other embodiments, these network services can be implemented on a fogSM or other network location that is not in the lead fogNode 108.

To be sure, the Ethernet TSN features implemented within the fog network 100 comprise TSN capable/enabled portions of the illustrated network, as well as any TSN related functionalities implemented therein by the control and management portions of the Fog network 100.

As noted, the TSN switches could be embedded within a fogNode (FN), or could be TSN capable devices. Of the many services offered within a Fog deployment, the following are of direct interest to the TSNs of the present disclosure. Centralized hosting of CNC/CUC functionalities, where these functions/components are hosted either within a Systems Manager (fogSM) on the cloud, or the lead fog node 108 within a federated Fog. Another service comprises Role Based Access Control (RBAC) for hosted services (like CNC/CUC). Application Hosting from SM/LFN onto fogNodes can also be implemented. Due to the unique formulation of a Fog, with one (or more) FN(s) participating in the management of resources distributed across the network, an opportunity exists for the use of an iterative, constraint optimized service deployment model.

A plurality of endpoints, such as TSN aware hosts (e.g., endpoints) 116-120 and a TSN unaware host 122 are included in the fog network 100. Additional or fewer endpoints can be implemented in accordance with the present disclosure. Moreover, additional or fewer TSN enabled and/or capable switches can also be utilized.

The CUC 112 is typically responsible for configuring TSN endpoints 116-120 to converse over the fog network 100. For example, the CUC 112 would be used to configure a TSN endpoint with the details of a Service Directory (which the endpoint would query to identify its conversation peer). For a given set of endpoints interested in a conversation over an Ethernet TSN, such as the fog network 100, the CUC 112 would determine any constraints on the requested conversation. These constraints could be “requested” by the endpoint (e.g., Endpoint A [TSN aware host 116] wants to talk to Endpoint B [TSN aware host 118] with a maximum latency, which can be measured/defined micro-seconds).

In some embodiments, these constraints could be inferred by the CUC 112 based on the conversing endpoints. By way of example, TSN aware host 116 desires to talk to TSN aware host 118, CUC 112 has been pre-programmed with a constraint that the maximum latency ought to be, for example 100 micro-seconds.

Requested constraints by the endpoints could be overridden or modified by the CUC 112 with a set of pre-ordained constraints. By way example, the CUC 112 can be configured to allow TSN aware or unaware hosts to converse over the Fog network 100 with a latency that is always less than 50 micro-seconds. Thus, requests for conversation constraints that would result in greater latency are overridden by the pre-ordained constraints. While latency is one example, any network constraint related to endpoint conversations can be pre-defined or pre-ordained in accordance with the present disclosure.

Once the conversation constraints are determined, the CUC 112 passes along these constraints to the CNC 114. In some embodiments, CNC 114 is responsible for provisioning network resources for a conversation between endpoints.

In some embodiments, this provisioning can comprise a determination of a TSN path between the communicating endpoints after accounting for a topology of the Fog network 100 and requested path constraints from the CUC 112. For example, a conversation between two TSN hosts may require traversal through one or more of the TSN enabled or capable switches of the Fog network 100.

Various paths are illustrated in FIG. 1 as dotted and/or solid lines extending between TSN components, which are indicative of communicative coupling.

Once a TSN path has been determined, the CNC 114 generates TSN configurations, which include the setup of VLANs, programming of TSN schedules (802.1qbv) and other related activities for individual TSN elements such as endpoints and the TSN switches along the path. In some embodiments, the CNC 114 can create TSN schedules and program the TSN switches in the fog network with the TSN schedules allowing for endpoint communications.

The generated configurations are then applied by the CNC 114 onto individual TSN elements (e.g., endpoints such as TSN hosts and the TSN switches, both capable and enabled, along the path.

The CNC 114 can utilize network management protocols (like NetCONF, RestCONF) to configure the TSN elements (e.g. switches and the endpoints). In some exemplary embodiments, the CNC 114 acts as a configurator “client” whereas the TSN elements act as a configurator “server”. From a network configuration perspective, the capabilities of the endpoints (e.g., hosts) determine whether the CNC 114 needs to “configure” a device or not.

A TSN capable endpoint would need to be configured with the necessary TSN configurations (such as schedules, VLAN re-writes, and so forth). For such endpoints, the CNC 114 would need to configure the endpoint directly.

In various embodiments, an endpoint which is not TSN capable would rely on some form of downstream TSN “proxy” functionality. For example, a proxy functionality is embedded within an ingress of a connected switch port of a downstream TSN switch. For such endpoints, the CNC 114 would be responsible for configuring the “proxy” device and not the endpoint itself. This method would be utilized for the TSN unware host 122. The ingress would be affiliated with the TSN enabled switch 105A that is illustrated to be in communicative coupling with the TSN unware host 122.

CNC 114 operation may function using a complete view of a topology of the fog network 100. The topology would comprise all components of the fog network 100 and their interconnectedness. This topological information for the fog network 100 can be made available to the CNC 114 in several ways. A device that exists upstream or “northbound” of the CNC 114 provides the topology information to the CNC. The topology could be defined by a fog administrator in some embodiments. In other embodiments, the CNC 114 discovers the topology by some means from the network itself, of a combination of both provided information and/or gathered information. The CNC 114, in one or more embodiments, collates (or learns) topology information based on Link Local Discovery Protocol (LLDP) running on individual TSN switches.

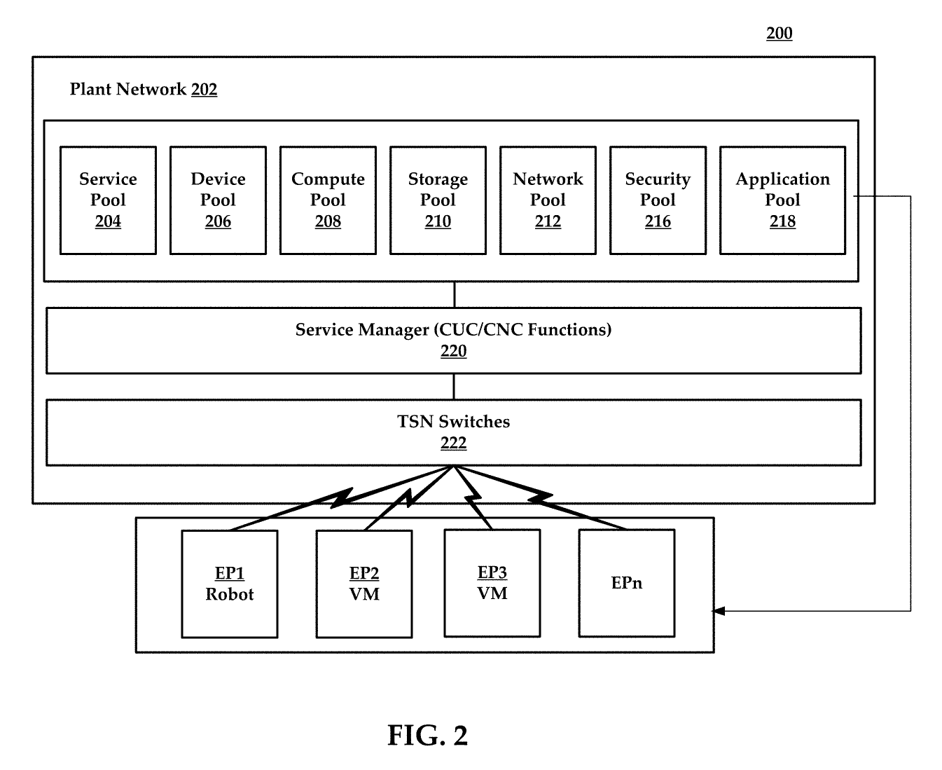

FIG. 2 illustrates another example Fog network 200 that comprises three end points such as EP1 that comprises a robot, EP2 that comprises a soft-PLC (programmable logic controller) executing within a virtual machine (VM), and EP3 that comprises a streaming analytics engine within another VM. Again, additional or fewer components can be utilized.

For context, traditional mechanisms for deploying the above three endpoints typically involve (1) identification of EP1 within the plant network; (2) setting up of a compute/storage element within the plant network for EP2/EP3, and (c) provisioning network and security infrastructure within a plant network (location where endpoints are located) to accommodate the selected compute/storage elements.

Any inconsistencies in the selection of the compute, storage, security or network resources results in a sub-optimal deployment of the solution. For example, the selected compute server may not have the necessary compute resources to accommodate the EP3 compute requirements. The location of the selected compute resource within the plant network may result in a large network delay (due to the number of network elements along the selected path) which may not be acceptable for the said solution. The version of applications running on EP2 and EP3 may be inconsistent, or even worse incompatible. An outage on EP2 could disrupt the entire service, probably needing user-intervention to re-deploy EP2. Migration of EP2 to a different compute element would trigger a re-evaluation of compute, storage, network and security needs against available pool of resources.

Thus the present disclosure provides a solution to these example deficiencies by implementing a plant network 202 that comprises a plurality of resource pools comprising service specific nodes such as a service pool 204 that includes a device pool 206, a compute pool 208, a storage pool 210, a network pool 212, a security pool 216, and an application pool 218. These components are part of an optimized service deployment solution within the plant network.

Services deployed onto the plant network 202 may have a corresponding resource profile. For example, the previously considered solution (with three endpoints) may be associated with: (a) a device profile with a specific make/model of Robot (EP1), and no device constraint on EP2 and EP3; (b) a compute profile with no compute constraints on the Robot (EP1), EP2 (one CPU cores with 4 GB RAM), and EP3 (two CPU cores with 16 GB RAM); (c) a storage profile with no constraints on EP1, EP2 (64 GB hard disk), and EP3 (256 GB hard disk); (d) a network profile with EP1 having conversation constraints with EP2, having a maximum latency of one millisecond, and EP2 having conversation constraints with EP3, having a maximum latency of fifteen milliseconds; (e) a security profile that allows EP1 and EP2 conversations and allows EP2 and EP3 conversations. Also, the fogSM can deny every other conversation involving EP1, EP2 and EP3; (f) an application profile is utilized that includes EP1 with firmware version A, EP2 with 1 Windows VM, and EP2 with 1 Linux VM and 2 Docker containers on host OS.

Since these resources are distributed across the Fog network 200, a central entity/node such as a system manager 220 can provision the necessary resources in an end-user transparent fashion such as identifying a device to satisfy the device profile of the service from the device pool 206, identifying a compute element to satisfy the compute profile of the service the compute pool 208; identifying a storage element to satisfy the storage profile of the service from the storage pool 210; identifying a network path to satisfy the network profile of the service from the network pool 212, and identifying of security resources to satisfy the security profile of the service from the security pool 216.

The service manager (fogSM) 220 may iterate thru the available elements within the various resource pools to find a fit for an endpoint's profile. As noted above, the fogSM 220 can be replaced by a CUC/CNC enabled lead fogNode. The service manager can include a virtualized service manager executing on a VM within the Fog network 200.

As noted above, various exemplary embodiments strive to arrive at an optimized solution in terms of device, compute, storage, network and security resources for the said application. Unlike traditional mechanisms, certain exemplary embodiments may be automated to iterate over various resource pools to find an optimum solution.

Further exemplary embodiments are modified to accept a service profile which restricts iterative procedures, for example where the fogSM is restricted to compute and storage alone, but not for a remainder of the resource pool.

In the embodiment of FIG. 2, it is possible for a service profile to indicate the fact that EP2 needs to be deployed onto a specific server (with a pre-ordained amount of CPU/memory/storage) located at a specific point in the Fog network 200. The iterative procedures for deploying the service would then honor static, pre-determined definitions and strive to achieve an optimized solution based on the variables that are iterable.

Unlike traditional mechanisms, exemplary embodiments may be automated to react to an update to the resource requirements of a given solution. This may be achieved by iterating thru the various resource pools within the Fog network 200 to find an optimum solution for a new set of resource requirements. For example, the service profile may be updated to reflect the need for EP2's Windows VM to be based off of Windows 10 server instead of Windows NT server.

The communication between the endpoints EP1-EP3 can be pathed through various TSN switches 222, which can include both TSN enabled and/or capable devices.

Various exemplary embodiments the fogSM may react to events, and restart an optimization procedure if any of the deployed endpoints encounter an alarm situation. For example, a deployed endpoint could encounter a failed hard-disk. This could result in a violation of storage requirements associated with the deployment solution on the said endpoint. Per some embodiments, the central management entity (fogSM or LFN) may restart the iterative method to identify and migrate various resources to another favorable entity within the plant network. These actions may be automated so as to provide for minimal disruption to services within the Fog network.

In some embodiments, a re-calculated resource allocation scheme is re-provisioned into the fog network without disrupting conversations between conversing ones of the plurality of end points

Example events include, but are not limited to failure of an end-point, movement of an end-point from one part of the fog network to another; and/or reduction in a service capability of one or more of the plurality of service specific nodes.

Some implementations may provide determinism between communicating end-points within an Ethernet TSN, these mechanisms are geared towards mostly static end-points. Such mechanisms expect a given Ethernet TSN to be setup once for communicating end-points to be identified and provisioned once, and these to remain in service for relatively long periods of time. By making end-points dynamic, both in terms of their provisioning but also in terms of their mobility within the Fog network, example embodiments of the present disclosure can provide for a superior service deployment mechanism than existing networks that can function only with static endpoints.

The presence of an Ethernet TSN within the Fog network 200, when used in conjunction with the above iterative model of optimizing resource placement, leads unique value propositions. The Ethernet TSN can be effectuated by TSN capable and/or enabled switches included in the Fog network 200, such as switches 222A-D.

In traditional networks, endpoints are considered to be “always-on”. As such, Admission Control (AC) within such networks primarily is typically concerned with how to “dis-allow” communication between end-points. This is in contrast to an Ethernet TSN (especially true within a Fog network of the present disclosure) wherein communicating end-points may be put in an “always-off” state. The CUC/CNC lead fog node (see FIG. 1) may be employed to selectively “turn-on” communication between a select set (two or more) of end-points. This ability, when combined together with the iterative resource optimized provisioning model outlined supra, provides for a unique and compelling close knit solution for deploying services.

Building upon the AC feature mentioned above, it is possible for an Ethernet TSN to provide fine grain Quality of Service (QoS) to participating end-points. Since the CUC is aware of communicating end-points, the CUC can now provision QoS to accommodate the following needs: (a) deterministic upper bounds of latency between communicating end-points; (b) no latency bounds, but provide for High Priority (HP) treatment for flows between communicating end-points; (c) no latency bounds, but guaranteed maximum bandwidth for flows between communicating end-points, or; (d) best effort servicing of flows.

Most existing QoS mechanisms provide a subset of the above in very specific deployment models. Various exemplary embodiments may be employed to provide for all the above QoS treatments to dynamic (and mobile) communicating end-points within a Fog.

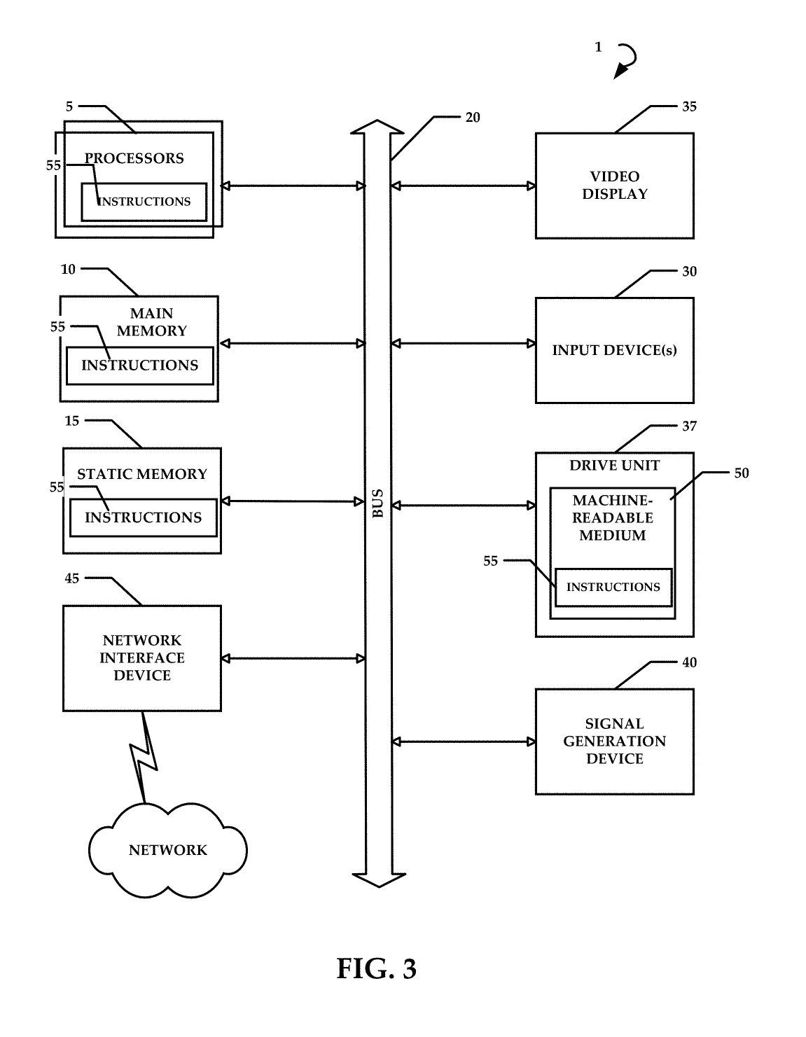

FIG. 3 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system, comprising:
a plurality of end points;
one or more fogNodes providing distributed resource management of resources from a plurality of service pools for the plurality of end points;
one or more time sensitive network (TSN) switches embedded within the one or more fogNodes; and
a system manager or lead fogNode of the one or more fogNodes that provides centralized management and selective distribution of plurality of resource pools to the plurality of end points using resource profiles for the plurality of end points.

2. The system according to claim 1, wherein the plurality of end points are either TSN capable or TSN non-capable.

3. The system according to claim 1, further comprising a proxy function embedded within an ingress of a connection port for each of the end points that are TSN non-capable, the proxy function providing the TSN capabilities.

4. The system according to claim 1, wherein the system is implemented a fog network.

5. A fog network, comprising:
a plurality of dynamic end points;
a plurality of service specific nodes offering one or more services comprising compute, storage, network, security, and business critical applications and functions;
one or more fog nodes providing distributed resource management for plurality of services; and
one or more system managers that provide centralized control of the one or more services to the plurality of dynamic end points.

6. The fog network according to claim 5, wherein the fog network is a centrally managed time sensitive network comprising:
an Ethernet time sensitive network (“TSN”) configured to communicate with the plurality of end points;
TSN switches;
a central user configurator that:
configures each of the plurality of end points for intercommunication over the TSN;
applies conversation constraints for a conversation between a portion of the plurality of dynamic end points; and
a central network configurator that:
receives the conversation constraints; and
calculates TSN schedules and provisions the TSN schedules into the TSN switches.

7. The system according to claim 5, wherein the central network configurator and the central user configurator are implemented as a lead fog node within the fog network.

8. The system according to claim 7, wherein the lead fog node is configured to function as a centralized control element that generates TSN schedules and provisions the plurality of end points with the schedules.

9. The system according to claim 8, wherein the lead fog node is configured to function as a centralized control element that allows the plurality of end points to generate TSN schedules and transmit the TSN schedules within the plurality of end points based on flow heuristics.

10. The fog network according to claim 9, wherein the fog network operates under two distinct sets of constraints, comprising:
business service resource constraints, requested by an operator of the fog network; and
conversation constraints, requested by one of the plurality of dynamic end points.

11. The fog network according to claim 10, wherein the business service resource constraints are processed by the one or more system managers by considering a plurality of resource profiles, comprising any combination of:
a node or device profile;
a compute profile;
a storage profile;
a network profile;
a security profile; and
an application profile.

12. The fog network according to claim 15, wherein a service resource constraint network profile is processed by a central user configurator.

13. The fog network according to claim 12, wherein the one or more system managers iteratively select a resource allocation scheme to satisfy the service resource constraints.

14. The fog network according to claim 13, wherein the one or more system managers provision one or more services the fog network based on the selected resource allocation scheme.

15. The fog network according to claim 14, wherein the one or more system managers trigger a re-calculation of the resource allocation scheme in response to an event selected from any of:
failure of a dynamic endpoint of the plurality of dynamic end points;
movement of a dynamic endpoint of the plurality of dynamic end points from one part of the fog network to another; and
reduction in a service capability of one or more of the plurality of service specific nodes.

16. The fog network according to claim 15, wherein the re-calculated resource allocation scheme is re-provisioned into the fog network without disrupting conversations between conversing ones of the plurality of dynamic end points.
